(19) United States
(12) Patent Application Publication
(10) Pub. No.: US 2010/0246186 A1
(43) Pub. Date: Sep. 30, 2010

(54) ILLUMINATION LAMP

(75) Inventors: CHIA-SHOU CHANG, Tu-Cheng (TW); LIN YANG, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: FU ZHUN PRECISION INDUSTRY (SHEN ZHEN) CO., LTD., Shenzhen City (CN); FOXCONN TECHNOLOGY CO., LTD., Tu-Cheng (TW)

(21) Appl. No.: 12/508,583

(22) Filed: Jul. 24, 2009

(30) Foreign Application Priority Data
Mar. 31, 2009 (CN) 200910301252.7

(51) Int. Cl. F21V 29/00; F21V 7/00

(52) U.S. Cl. 362/294; 362/310; 362/297

(57) ABSTRACT

An illumination lamp includes a housing, light source, a light reflecting device and a light path conversion device. The housing defines a light emitting window therein. The light source is disposed in the housing. The light reflecting device is disposed in the housing and has a reflecting surface. The light path conversion device is disposed in the housing. The light path conversion device is configured for converting light rays emitted from the light source into parallel light rays and directing the parallel light rays toward the light reflecting surface of the light reflecting device. The light reflecting device reflects the parallel light rays out of the housing via the light emitting window.

### BACKGROUND

1. Technical Field

The present invention relates generally to an illumination lamp, and more particularly to an illumination lamp capable of evenly illuminating a large area.

2. Description of Related Art

Presently, LEDs are preferred for use in non-emissive display devices than CCFLs (cold cathode fluorescent lamp) due to their high brightness, long lifespan, and wide color range. However, the LED is a point light source, and an emitting surface thereof is usually hemispherical. Intensity of a light field of the LED decreases gradually and outwardly along a radial direction thereof. The intensity of the light field of the LED is uneven, being strong at a center of the light field and weak at a periphery of the light field.

Therefore, it is desirable to provide an illumination lamp to overcome the above-mentioned shortcoming.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 an isometric view of an illumination lamp according to a first embodiment of the present invention.

FIG. 2 is a cross-sectional view of the illumination lamp of FIG. 1, taken along line II-II thereof.

FIG. 3 is an isometric view of an illumination lamp according to a second embodiment of the present invention.

FIG. 4 is a cross-sectional view of the illumination lamp of FIG. 3, taken along line IV-IV thereof.

FIG. 5 is an exploded view of an illumination lamp according to a third embodiment of the present invention.

FIG. 6 is an assembled isometric view of the illumination lamp of FIG. 5.

FIG. 7 is a cross-sectional view of the illumination lamp of FIG. 6, taken along line VII-VII thereof.

FIG. 8 is an isometric view of a reflecting device of the illumination lamp of FIG. 6.

FIG. 9 is an exploded view of the reflecting device of FIG. 8.

FIG. 10 is an isometric view of an illumination lamp according to a fourth embodiment of the present invention.

FIG. 11 is a cross-sectional view of the illumination lamp of FIG. 10, taken along line XI-XI thereof.

FIG. 12 is an exploded view of the illumination lamp of FIG. 10.

### DETAILED DESCRIPTION

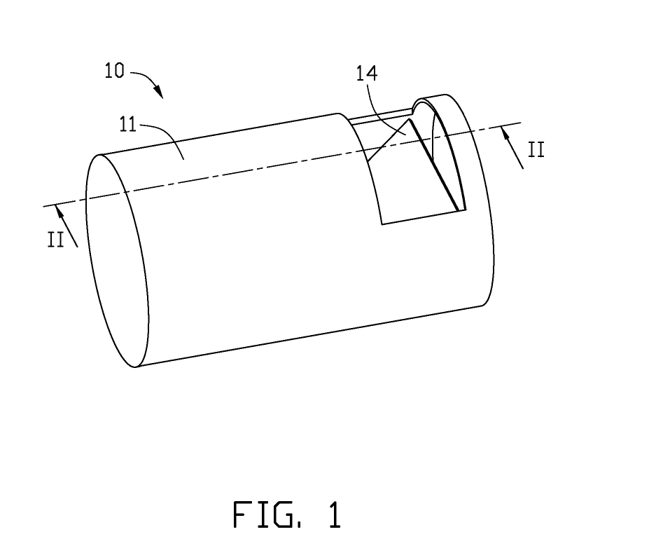

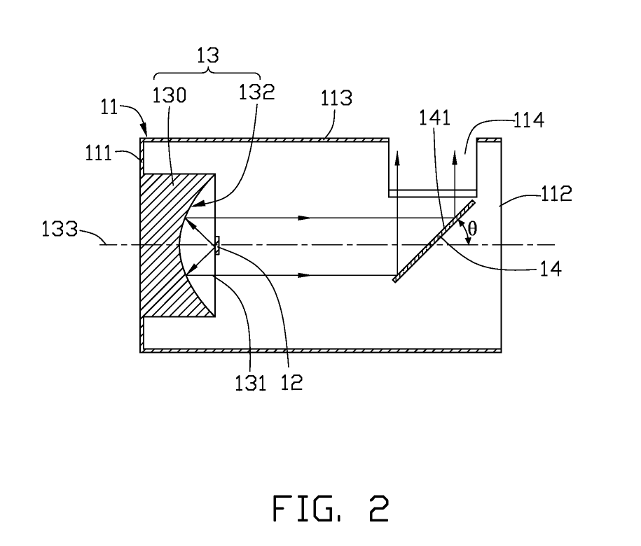

Referring to FIGS. 1-2, an illumination lamp 10 according to an exemplary embodiment of the present invention includes a cylindrical housing 11, an LED light source 12, a light path conversion device 13 and a light reflecting device 14.

The light path conversion device 13 includes a protrusion 130 and a paraboloid 132 recessed in the protrusion 130. The protrusion 130 is column-shaped and extends axially and inwardly from an axial end 111 of the housing 11. The protrusion 130 has a central axis 133 coaxial with a central axis of the housing 11. The protrusion 130 has a near end connected with the axial end 111 of the housing and a distal free end. The paraboloid 132 is defined in the distal free end of the protrusion 130. An opening 131 of the paraboloid 132 faces another axial end 112 of the housing 11. The LED light source 12 is located at a focus point of the paraboloid 132 and faces the paraboloid 132.

The light reflecting device 14 is a rectangle-shaped plate and has a light reflecting surface 141 facing the LED light source 12. The light reflecting device 14 is disposed in the housing 11 and adjacent to the another axial end 112 of the housing 11. The paraboloid 132 and the light reflecting device 14 are disposed at a left side and a right side of the LED light source 12, respectively. A center of the light reflecting device 14 is disposed at the central axis 133 of the paraboloid 132. The light reflecting device 14 is inclined at an acute angle 0 with respect to the central axis 133 of the paraboloid 132. An outer peripheral surface 113 of the housing 11 defines a light emitting window 114 adjacent to the light reflecting device 14. The light reflecting surface 141 of the light reflecting device 14 faces the light emitting window 114.

The light rays emitted by the LED light source 12 which is disposed at the focus point of the paraboloid 132 travel in a direction from the LED light source 12 toward the paraboloid 132. After the light rays are reflected by the paraboloid 132, the originally radiate light rays from the LED light source 12 are converted into parallel light rays by the paraboloid 132 and then travel along a direction from the paraboloid 132 toward the light reflecting device 14. Then, the parallel light rays are reflected by the light reflecting device 14 and redirected toward the light emitting window 114. The parallel light rays continue their ways out of the housing 11 via the light emitting window 1 14.

The paraboloid 132 redirects the non-parallel light rays emitted by the LED light source 12 into the parallel light rays toward the light reflecting device 14. Thus, the LED light source 12 which is a point light source is transformed to a surface light source and the illumination lamp 10 is capable of evenly illuminating objects through the light emitting window 114.

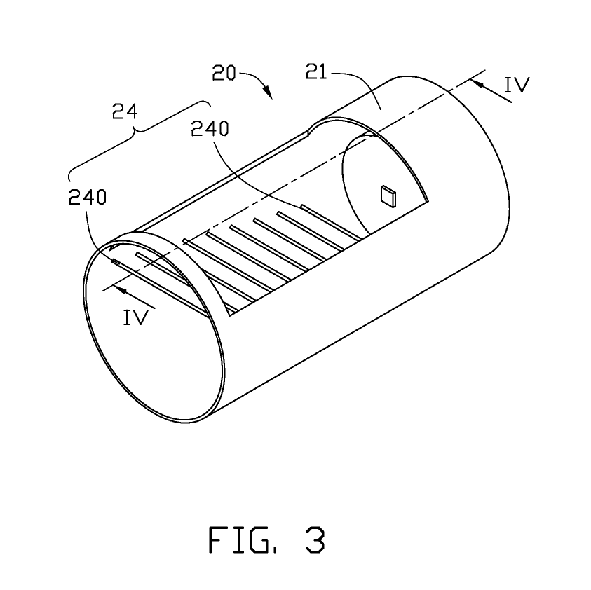

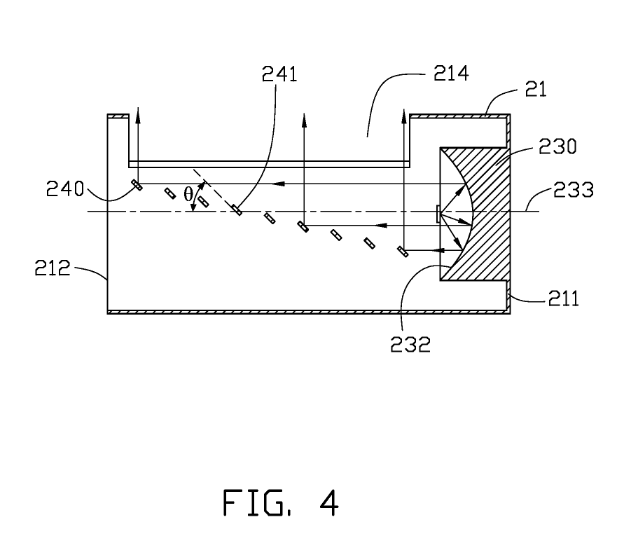

FIGS. 3-4 show an illumination lamp 20 according to a second alternative embodiment. The difference lies in the light reflecting device 24. In this alternative embodiment, the light reflecting device 24 is ladder-shaped and includes a plurality of parallel rectangle-shaped reflectors 240 disposed in the housing 21. The reflectors 240 are offset from each other, with a distance between each reflector 240 and the light emitting window 214 gradually decreased along the central axis 233 from the first axial end 211 from which the protrusion 230 is formed towards the opposite second axial end 212 of the housing 21. Each reflector 240 is inclined at an acute angle 0 with respect to a central axis 233 of the paraboloid 232. Each reflector 240 has a reflecting surface 241 facing the light emitting window 214. The parallel light rays redirected by the paraboloid 232 are emitted outwards through the light emitting window 214 via the reflectors 240.

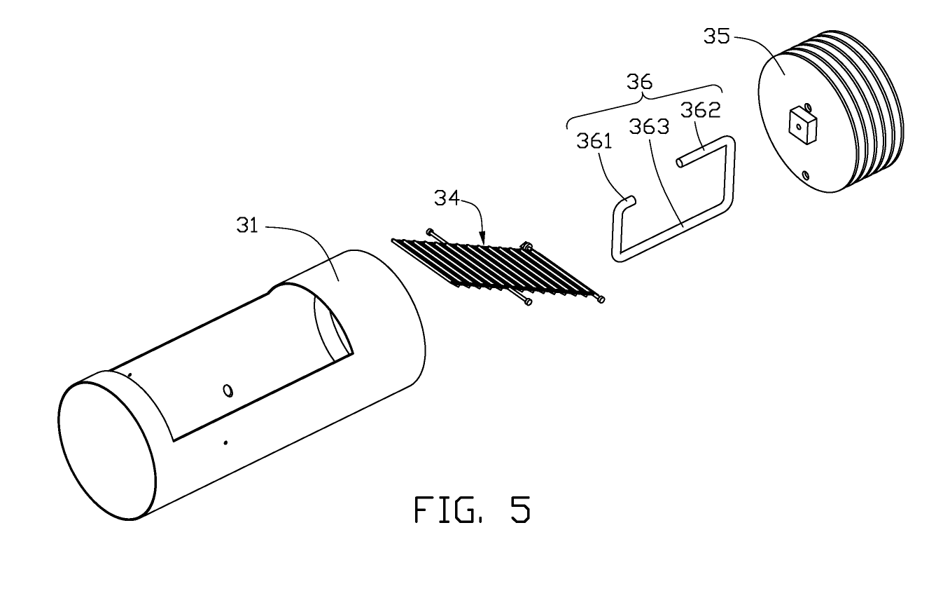

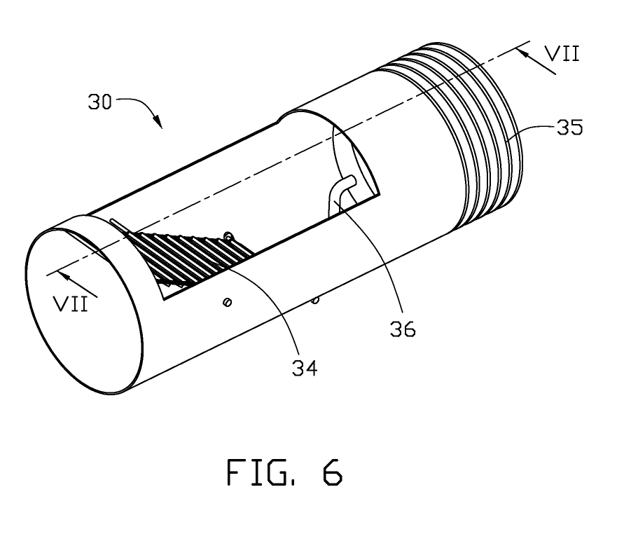

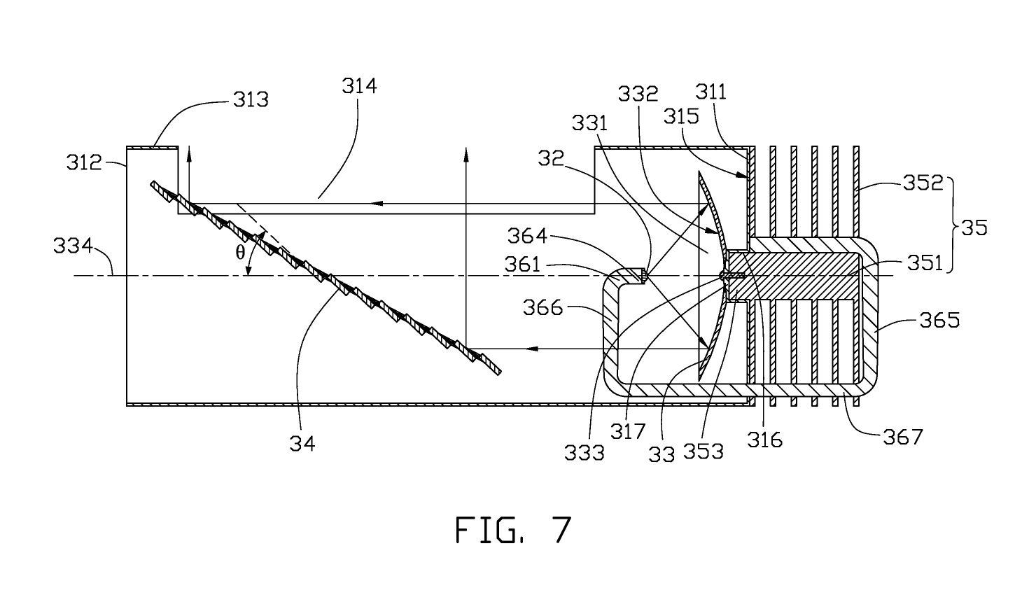

Referring to FIGS. 5-7, an illumination lamp 30 according to a third embodiment of the present invention includes a cylindrical-shaped housing 31, a light reflecting device 34, a heat pipe 36, a heat sink 35, a light path conversion device 33 and an LED light source 32.

The housing 31 has a circular and flat mounting surface 315 at an axial end 311 thereof. A center of the mounting surface 315 defines a mounting recess 316 thereby forming a protrusion 317 in the housing 31.

The heat sink 35 includes a pole 351 and a plurality of circular fins 352 surrounding the pole 351 and spaced from each other. The heat sink 35 is disposed at an outer side of the housing 31 and an end 353 of the pole 351 is inserted into the mounting recess 316 of the mounting surface 315 and fixed on the mounting surface 315 via a screw 333.

The light path conversion device 33 is a cup-shaped light reflector and defines a paraboloid 332 at an inner surface thereof. The light path conversion device 33 is mounted to the protrusion 317 of the housing 31 and an opening 331 of the paraboloid 332 faces the light reflecting device 34. The screw 333 extends successively through a center of the light path conversion device 33 and the protrusion 317 and is eventually connected with the pole 351 of the heat sink 35.

The heat pipe 36 is curved and includes an evaporator section 361, a condenser section 362 and an adiabatic section 363. The evaporator section 361 and the condenser section 362 are disposed at two opposite ends of the heat pipe 36. The adiabatic section 363 is disposed between the evaporator section 361 and the condenser section 362. The adiabatic section 363 is U-shaped and includes a first vertical portion 365 connected with the condenser section 362, a second vertical portion 366 connected with the evaporator section 361 and a lateral portion 367 disposed between the first vertical portion 365 and the second vertical portion 366. The evaporator section 361 is disposed in the housing 31. A free end 364 of the evaporator section 361 is located at a focus point of the paraboloid 332 and faces the opening 331 of the paraboloid 332. The LED light source 32 is disposed at the free end 364 of the evaporator section 361, whereby the LED light source 32 is disposed at the focus point of the paraboloid 332. The lateral portion 367 of the adiabatic section 363 and the condenser section 362 extend through the fins 352 of the heat sink 35 whereby the lateral portion 367 of the adiabatic section 363 and the condenser section 362 are connected with the heat sink 35.

The light reflecting device 34 is received in the housing 31 and located at the another axial end 312 of the housing 31 far away from the heat sink 35, whereby the light reflecting device 34 and the light path conversion device 33 are disposed at two opposite sides of the LED light source 32. An outer peripheral surface 313 of the housing 31 defines a light emitting window 314 adjacent to the light reflecting device 34.

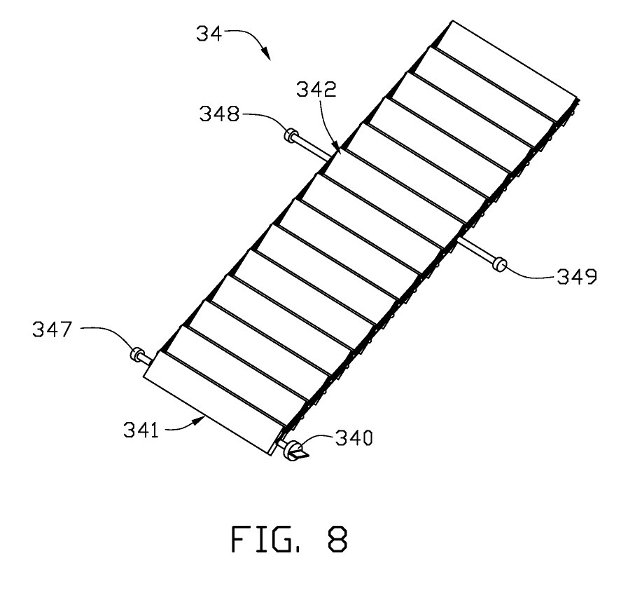

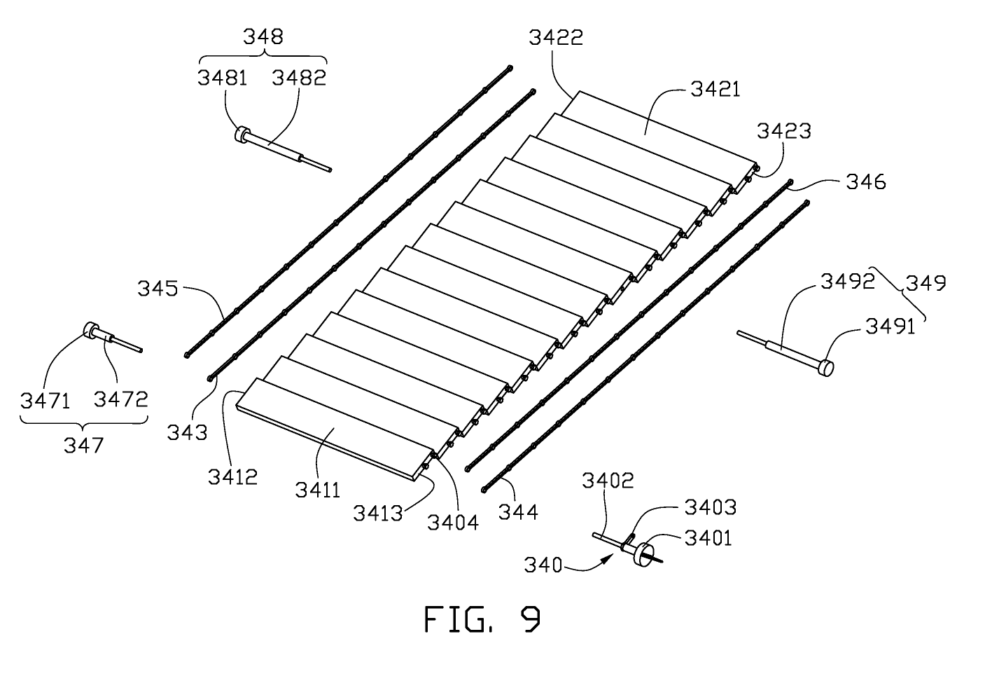

Referring to FIGS. 8-9, the light reflecting device 34 includes a driving reflector 341, a plurality of follower reflectors 342 parallel to the driving reflector 341, a first connecting bar 343, a second connecting bar 344, a third connecting bar 345, a fourth connecting bar 346, a first supporting pole 347, a second supporting pole 348, a third supporting pole 349 and a rotating pole 340.

The driving reflector 341 and each of the follower reflectors 342 is rectangle-shaped and includes a light reflecting surface 3411, 3421, a first side surface 3412, 3422 and a second side surface 3413, 3423. The first side surface 3412, 3422 and the second side surface 3413, 3423 are opposite and disposed at a left side and a right side of the light reflecting surface 3411, 3421. The light reflecting surfaces 3411, 3421 of the driving reflector 341 and the follower reflectors 342 cooperatively form a light reflecting surface of the light reflecting device 34. The light reflecting surface of the light reflecting device 34 faces the light emitting window 314.

The first connecting bar 343 and the third connecting bar 345 are disposed at a left side of the light reflecting device 34 and pivotally connected with each of the first side surfaces 3412, 3422 of the driving reflector 341 and the follower reflectors 342. The second connecting bar 344 and the fourth connecting bar 346 are disposed at a right side of the light reflecting device 34 and pivotally connected with each of the second side surfaces 3413, 3423 of the driving reflector 341 and the follower reflectors 342. The fourth connecting bar 346 and the driving reflector 341 have a pivotal connection point 3404 at the second side surfaces 3413 of the driving reflector 341.

Each of the first supporting pole 347, the second supporting pole 348 and the third supporting pole 349 includes a body portion 3472, 3482, 3492 and a head portion 3471, 3481, 3491. The rotating pole 340 includes a body portion 3402, a head portion 3401 and a crank portion 3403. The crank portion 3403 of the rotating pole 340 extends radially and outwardly from an outer peripheral surface of the body portion 3402 of the rotating pole 340.

The first supporting pole 347 and the rotating pole 340 are symmetrically disposed at a left side and a right side of the driving reflector 341, respectively. The body portion 3472 of the first supporting pole 347 extends successively through the housing 31 and the first connecting bar 343 and is pivotally connected with the driving reflector 341. The head portion 3471 of the first supporting pole 347 resists on the outer peripheral surface 313 of the housing 31. The body portion 3402 of the rotating pole 340 extends successively through the housing 31 and the second connecting bar 344 and is pivotally connected with the driving reflector 341. The head portion 3401 of the rotating pole 340 resists on the outer peripheral surface 313 of the housing 31. The crank portion 3403 of the rotating pole 340 is pivotally connected with the driving reflector 341 at the pivotal connection point 3404.

The second supporting pole 348 and the third supporting pole 349 are symmetrically disposed at a left side and a right side of the follower reflector 342, respectively. The body portion 3482 of the second supporting pole 348 extends successively through the housing 31 and the first connecting bar 343 and is pivotally connected with the follower reflector 342. The head portion 3481 of the second supporting pole 348 resists on the outer peripheral surface 313 of the housing 31. The body portion 3492 of the third supporting pole 349 extends successively through the housing 31 and the second connecting bar 344 and is pivotally connected with the follower reflector 342. The head portion 3491 of the third supporting pole 349 resists on the outer peripheral surface 313 of the housing 31.

When the rotating pole 340 is rotated under an external force, the crank portion 3403 of the rotating pole 340 can make the driving reflector 341 rotate with the rotating pole 340, whereby the third connecting bar 345 and the fourth connecting bar 346 can move parallel to the first connecting bar 343 and the second connecting bar 344. The movement of the third connecting bar 345 and the fourth connecting bar 346 can make the follower reflectors 342 rotate at a same rotating speed as the driving reflector 341. Thus, the angle 0 between the light reflecting device 34 and the central axis 334 of the paraboloid 332 can be adjusted to change an incident angle of the light rays at the light reflecting surface of the light reflecting device 34. Therefore, the direction of the light rays emitted from the illumination lamp 30 can be conveniently adjusted to satisfy various luminous requirements. The heat generated by the LED light source 32 can be transferred to the heat sink 35 via heat pipe 36 and dissipated into an outer atmosphere via the heat sink 35.

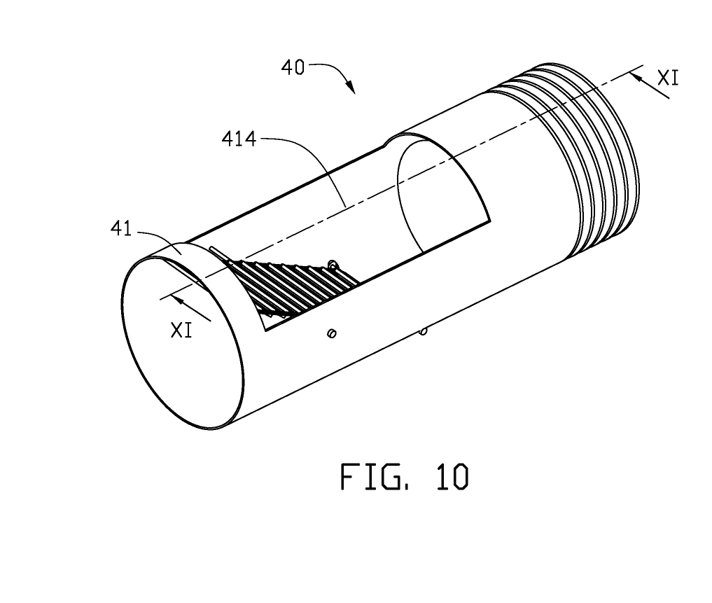

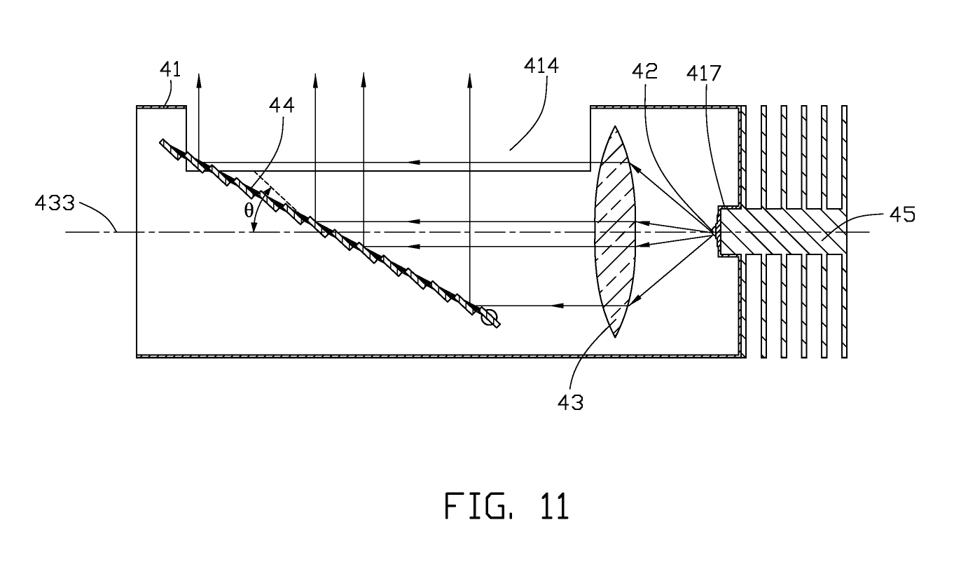

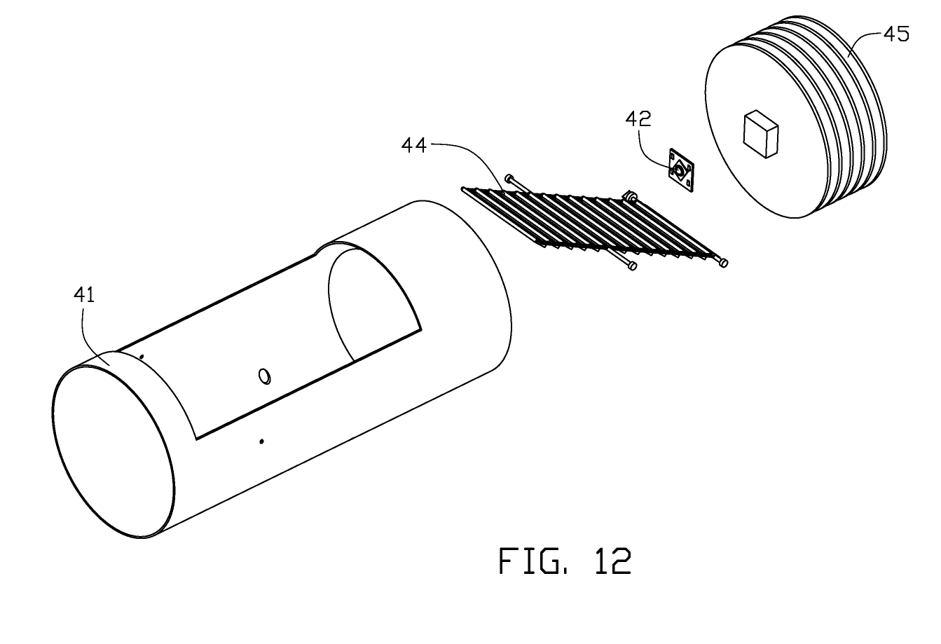

Referring to FIGS. 10-12, an illumination lamp 40 according to a fourth embodiment of the present invention includes a cylindrical-shaped housing 41, a light reflecting device 44, a heat sink 45, a light path conversion device 43 and an LED light source 42. The light path conversion device 43 is a biconvex lens. The biconvex lens is disposed in the housing 41. An optical axis 433 of the biconvex lens is coaxial with the central axis of the housing 41. A center of the protrusion 417 is disposed at a right focus point of the biconvex lens. The LED light source 42 is disposed at the center of the protrusion 417 and faces the biconvex lens, whereby the LED light source 42 is disposed at the right focus point of the biconvex lens. The light reflecting device 44 and the LED light source 42 are disposed at a left side and a right side of the biconvex lens. The light reflecting device 44 is inclined at an angle θ with respect to the optical axis 433 of the biconvex lens and the light reflecting surface of the light reflecting device 44 faces the light emitting window 414.

The light rays emitted by the LED light source 42 travel in a direction from the LED light source 42 toward the biconvex lens. After the light rays pass through the biconvex lens, the light rays are transformed to parallel light rays and then continue to travel toward the light reflecting device 44. The parallel light rays are reflected by the light reflecting device 44 and redirected toward the light emitting window 414. The light rays continue their ways out of the housing 41 via the light emitting window 414. Since the LED light source 42 is disposed at the protrusion 417 of the housing 41, the heat generated by the LED light source 42 can be transferred to the heat sink 45 via the protrusion 417 and dissipated into the outer atmosphere via the heat sink 45.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An illumination lamp comprising:
a housing defining a light emitting window therein;
a light source disposed in the housing;
a light reflecting device disposed in the housing and having a light reflecting surface; and
a light path conversion device disposed in the housing and configured for converting light rays emitted from the light source into parallel light rays and directing the parallel light rays toward the light reflecting surface of the light reflecting device, the light reflecting device reflecting the parallel light rays out of the housing via the light emitting window.

2. The illumination lamp as claimed in claim 1, wherein the light source is an LED light source.

3. The illumination lamp as claimed in claim 1, wherein the light path conversion device is a convex lens, the light source and the light reflecting device being disposed at two opposite sides of the convex lens, and the light source being disposed at a focus point of the convex lens.

4. The illumination lamp as claimed in claim 3, wherein an optical axis of the convex lens is coaxial with a central axis of the housing, the light reflecting device being inclined at an acute angle with respect to the optical axis of the convex lens, the light reflecting surface of the light reflecting device facing the light emitting window.

5. The illumination lamp as claimed in claim 4 further comprising a heat sink being disposed at an outside of the housing and connected with an axial end of the housing, the light source being disposed at the axial end of the housing and in thermal connection with the heat sink.

6. The illumination lamp as claimed in claim 1, wherein the light path conversion device has a paraboloid defined therein, the paraboloid and the light reflecting device being disposed at two opposite sides of the light source, the light source being disposed at a focus point of the paraboloid.

7. The illumination lamp as claimed in claim 6, wherein a central axis of the paraboloid is coaxial with a central axis of the housing, the light reflecting device being inclined at an acute angle with respect to the central axis of the paraboloid, the light reflecting surface of the light reflecting device facing the light emitting window.

8. The illumination lamp as claimed in claim 7, wherein a protrusion extends axially and inwardly from an axial end of the housing, the paraboloid being defined in a distal free end of the protrusion.

9. The illumination lamp as claimed in claim 6 further comprising a heat sink and a heat pipe, the heat sink being disposed at an outside of the housing and connected with an axial end of the housing, the heat pipe having an evaporator section being disposed in the housing and a condenser section being in thermal connection with the heat sink, the light source being disposed at a free end of the evaporator section.

10. The illumination lamp as claimed in claim 1, wherein the housing is cylindrical-shaped, the light source being disposed adjacent to an axial end of the housing, the light reflecting device being disposed adjacent to another axial end of the housing, the light emitting window being defined at an outer peripheral surface of the housing.

11. The illumination lamp as claimed in claim 1, wherein the light reflecting device is a plate type light reflector.

12. The illumination lamp as claimed in claim 1, wherein the light reflecting device is ladder-shaped and includes a plurality of reflectors offset and spaced from each other.

13. The illumination lamp as claimed in claim 1, wherein the light reflecting device includes a plurality of reflectors, and the reflectors are rotatably disposed in the housing.

14. The illumination lamp as claimed in claim 13, wherein the light reflecting device further comprises a rotating pole being connected with one of the plurality of reflectors, the rotating pole being configured for make the plurality of reflectors to rotate thereby adjusting a direction of the parallel light rays reflected by the light reflecting device.
